(19) United States
(12) Patent Application Publication
(10) Pub. No.: US 2005/0183867 A1
(43) Pub. Date: Aug. 25, 2005

(54) Concealing fire extinguisher storage device

(76) Inventor: Thomas A. Gaskill, Frenchtown, NJ (US)

Correspondence Address: Kenneth P. Glynn, Esq.;Glynn & Associates, P.C., 24 Mine Street, Flemington, NJ, 08822, US

(21) Appl. No.: 10/783,482

(22) Filed: Feb. 20, 2004

(51) Int. Cl. A62C 11/00; A62C 8/00; A62C 27/00; A62C 29/00; A62C 25/00

(52) U.S. Cl. 169/30; 169/71; 169/51

(57) ABSTRACT

The present invention relates to concealing fire extinguisher storage devices. In some preferred embodiments, the device is a stand-up device that may typically be placed on a floor, and in others, it is a wall-mounted device. The device includes a base having a front and a back, and having a flat bottom, and having a top adapted to receive a cylindrical fire extinguisher. It also has a curtain attachment means for attaching a curtain thereto, the curtain attachment means being adjacent the top and the front of the base. There is also a curtain attached to the curtain attachment means, the curtain being located at the front of the base and extending upwardly therefrom. The curtain is of sufficient height to conceal a cylindrical fire extinguisher, and has a façade with a decorative theme thereon. The wall mounted version includes provision for mounting on a wall.

### BACKGROUND OF THE INVENTION

1. Field of the Invention

The present invention relates to storage devices for fire extinguishers, and more particularly, to such devices that are floor stands with concealing features, so that the fire extinguishers are easily accessible, but are out of sight. The devices of the present invention include a base and a concealing curtain attached to the base. This curtain may be a wood, plastic or metal member and is fixedly or movably attached to the base.

2. Information Disclosure Statement

The following prior art is representative of the state of the art in the field of Fire extinguisher holders:

U.S. Pat. No. 5,555,938 describes a picture-combined fire extinguisher that is characterized by a glass-shelled extinguisher having a frame, to which a show window is pivotally connected. The show window consists of a clear panel, and an outer frame which extends backward and inward to from a space allowing a picture to be inserted therein behind the panel. Luminous and protective pads are provided at corners of the frame of the extinguisher so that the extinguisher may be easily and timely identified and accessed even in a dark place or in the nighttime without lighting. Meanwhile, the picture-combined fire extinguisher functions not only as a fire extinguisher but also as an aesthetic article.

U.S. Pat. No. 5,975,475 describes a fire extinguisher holder that provides for the removable retention of a fire extinguisher therein, for use in the home, office, or other immovable structure where the immobility of the structure precludes any requirement for positive clamping or attachment of the extinguisher in the holder. The present holder comprises a back panel, a base for supporting a fire extinguisher thereon, and an encircling element for precluding lateral movement of the extinguisher until it is lifted clear of the encircling element. The present extinguisher holder is constructed as a single, unitary structure and is devoid of any movable extinguisher retaining elements which would otherwise have to be manipulated in order to remove the extinguisher from the holder. The present holder allows a fire extinguisher held therein to be removed quickly and easily, without any requirement for releasing retaining straps and the like. The present extinguisher holder may be constructed of various materials, but is preferably constructed of wood, in order to provide an attractive appearance and encourage installation in the home or office, thereby promoting safety. Other elements of the holder, such as the concave insets and convex curvature of the upper portion of the back panel, provide functional advantages, such as clearance for grasping the extinguisher and removal of sharp comers, as well as providing an attractive appearance for the device.

Notwithstanding the prior art, the present invention is neither taught nor rendered obvious thereby.

### SUMMARY OF THE INVENTION

The present invention relates to concealing fire extinguisher storage devices. In some preferred embodiments, the device is a stand-up device that may typically be placed on a floor, such as in a comer a few feet from a fireplace, or on furniture or a kitchen counter, or outdoors near a fire pit, barbeque or the like. This standing unit includes a base having a front and a back, and having a flat bottom, and having a top adapted to receive a cylindrical fire extinguisher. It also has a curtain attachment means for attaching a curtain thereto, the curtain attachment means being adjacent the top and the front of the base. There is also a curtain attached to the curtain attachment means, the curtain being located at the front of the base and extending upwardly therefrom. The curtain is of sufficient height to conceal a cylindrical fire extinguisher, and has a façade with a decorative theme thereon.

The curtain may be a solid planar member made of a material selected from the group consisting of metal, wood, plastic and combinations thereof. It could be made of ceramic or cermet or natural materials, such as reed or wicker. It could be made flat, curved or three dimensional.

The base may be of any top view shape, but needs sufficient flatness at its top to support a fire extinguisher resting thereon. For example, it could be a substantially circular shape from a top view, or it could be a substantially rectilinear shape from a top view, or have any other shape. In those situations where the base is curved, circular or oval, or partially arcuated, the curtain could be a curvilinear member having an arcuate shape from a top view.

It is most advantageous and desirable that the concealing fire extinguisher storage device curtain has a theme, decorative, architectural, artistic or otherwise. These could involve sports, such as golf or soccer, or could involve holidays, such as Christmas or Halloween or Easter. They could be contemporary, country, religious Victorian or otherwise. In some embodiments, the front perimeter may be in the shape of a predetermined theme. Thus, the curtain may be made of solid wood. For example, an outline a golf bag and clubs, with painted or printed decorative details on the front. The front of the curtain could be molded plastic with a three dimensional frame. It could have a recessed area for insertion of one or more items, such as a curtain that is a flattened golf bag with a recess, and with actual miniature clubs in the recess. Or the curtain could be a flattened flower vase, with a recess containing dried, artificial, plastic, silk or fresh flowers.

The top of the base, in some embodiments, may include a circular shaped recess area adapted to receive a fire extinguisher. The base may be large enough to receive different size extinguishers, or even multiple extinguishers, as a matter of design.

The curtain may be permanently and fixedly attached to the base or it may be removably attached to the base. It may also be stationary or movable, whether or not it is permanently attached to the base. The attachment means may be as simple as one or more screws or nails or other fasteners, or more complex, such as a finger and slot fittage or any other available fittage to assemble two pieces together at approximate right angles. Alternatively, the present invention device could be unistructurally formed so that both the curtain and the base are formed or molded in a single step, and the connecting interface is the attachment means.

In other embodiments, the curtain may be able to be slid aside, folded down, rotated, or otherwise shifted without detachment from the base for easier access to the extinguisher. There may be two or more diverse members to the curtain, such as a metal frame, e.g., like an inverted flat topped “U”, with a cloth or other flexible fabric curtain member thereon. Thus, the present invention concealing fire extinguisher storage device curtain may have a plurality of interchangeable curtain members that are removably attachable to the base. These could be flexible or rigid, fabric or other material, and could have different seasonal themes, for example.

In another embodiment of the present invention, the concealing fire extinguisher storage device is modeled for wall or other vertical mount. It includes the base of the type described above, attachment means, a curtain as described above, and additionally, a wall attachment means connected to the back of the base. (This should be taken to also mean on the top of the base near or at the back of the base).

The concealing fire extinguisher storage device of the present invention may have a wall attachment means that may be a vertically extending member attached to the base, and that includes at least one of a wall attachment fastener and a wall attachment fastener orifice. This could be a screw or nail, a hanger or recess for placement on a nail, an orifice or mark for a nail or screw, or any other known or available mechanism that could be used. In these embodiments for wall or other vertical mounting, it is preferred, but not required, wherein the curtain is moveable to create frontal access to a fire extinguisher.

### BRIEF DESCRIPTION OF THE DRAWINGS

The present invention should be more fully understood when the specification herein is taken in conjunction with the drawings appended hereto wherein:

FIG. 1 illustrates a front view of one embodiment of the present invention concealing fire extinguisher storage device;

FIG. 2 shows a side view of the device shown in FIG. 1;

FIG. 3 shows an oblique rear view of the present invention device shown in FIGS. 1 and 2;

FIG. 4 illustrates a front view of another preferred embodiment of the present invention;

FIG. 5 illustrates a top view of the present invention device shown in FIG. 4;

FIG. 6 illustrates a front view of another preferred embodiment of the present invention device;

FIG. 7 shows a side view of the present invention device shown in FIG. 6;

FIGS. 8, 9, and 10 illustrate front, side and cut front views a preferred embodiment of the present invention device for wall mounting.

### DETAILED DESCRIPTION OF THE PRESENT INVENTION

The salient features are that the present invention devices are self-supporting and are aesthetically pleasing. A front curtain may preferably include a theme or other decorative or interesting presentation thereon. The phrase “curtain” in the context of this invention means something that conceals an object, in this case, one or more fire extinguishers. Thus, the curtain is a generally upwardly extending member that is attached to the front of a base, and that may be rigid, or a framed semi-rigid or flexible material. In those cases where a frame is utilized, the frame itself must be rigid and be connected to the base.

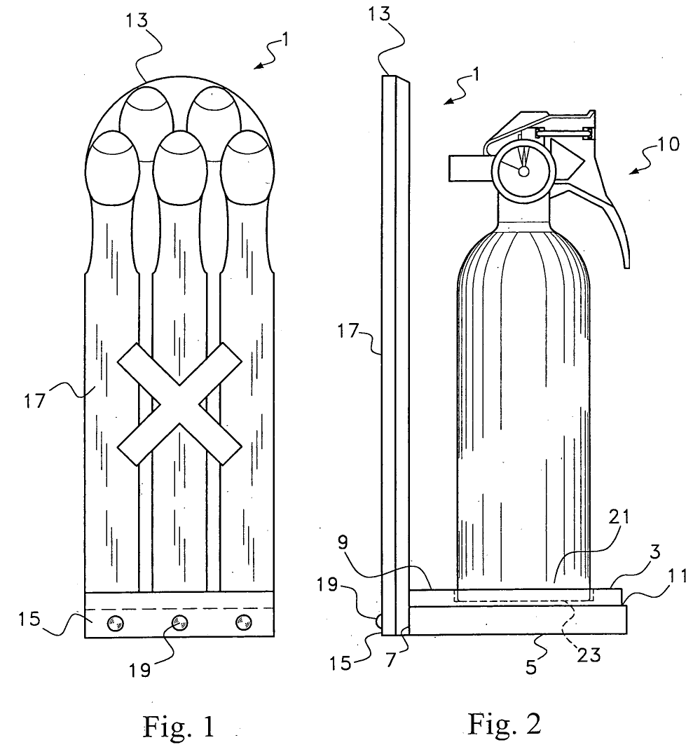

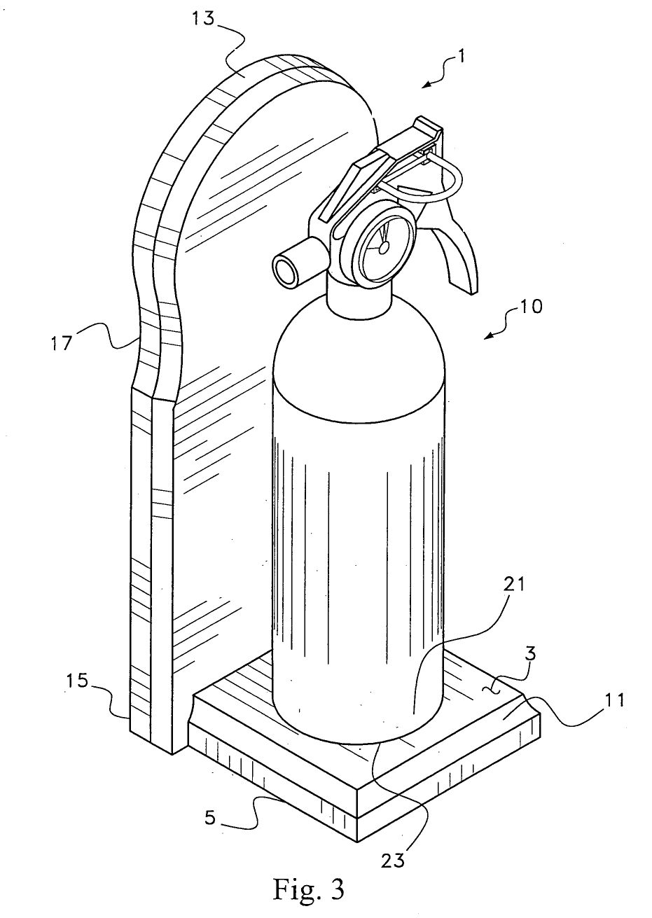

FIG. 1 illustrates a front view of one embodiment of the present invention concealing fire extinguisher storage device 1, that includes a solid structured curtain 17, with a decorative feature thereon. In this case, a partial, open book of matches with a negating cross is shown. It has a top 13 and a bottom 15, with attachments means screws, such as screw 19, for permanent, immobile attachment to base 3, shown in FIGS. 2 and 3. FIG. 2 shows a side view of the device 1 shown in FIG. 1 and FIG. 3 shows an oblique rear view of the present invention device 1 shown in FIGS. 1 and 2. Further discussion is intended to encompass all three Figures.

Base 3 has a flat bottom 5 so that it can stand on its own. It also has a recess 23 at base top 9 for receiving fire extinguisher 10 at its flat, circular bottom 21. Curtain 17 is attached at base front 7. Device 1 may be placed strategically on a floor area or other flat horizontal surface to make the extinguisher readily accessible when needed, yet is otherwise concealed by an interesting decorative presentation.

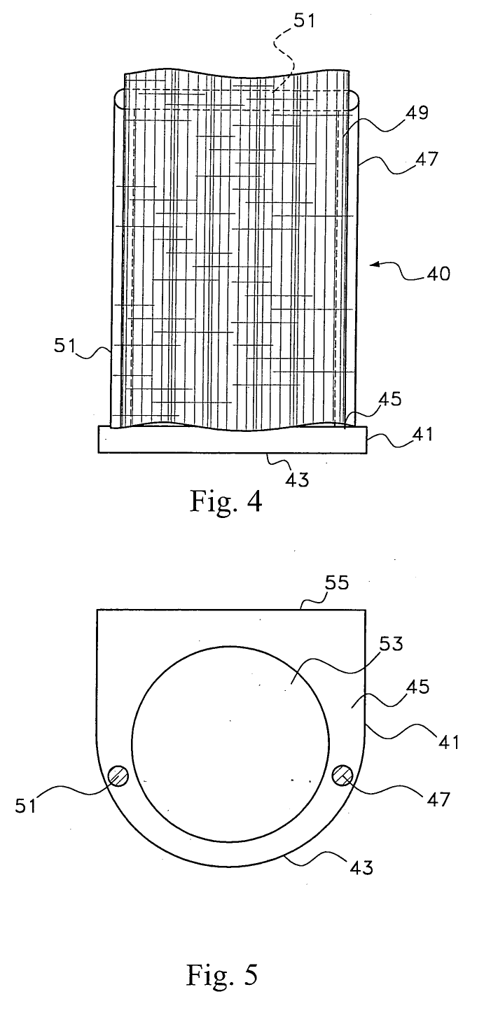

FIG. 4 illustrates a front view of another preferred embodiment of the present invention device 40 and FIG. 5 illustrates a top view of the present invention device 40. It includes a base 41 with a front 43, a top 45, with recess 53, and a back 55, as shown. Rigid uprights 47 and 51 are embedded in base 41, as shown. They are connected by rod 51, which holds a fabric curtain member 49, that may have any desired design, including matching a room's curtains, pillows or other accouterments.

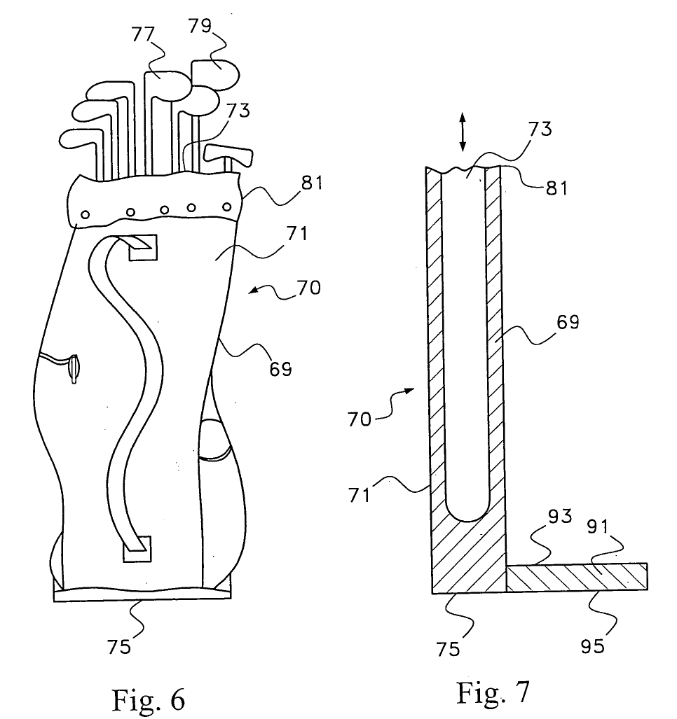

FIG. 6 illustrates a front view of another preferred embodiment of the present invention device 70, and FIG. 7 shows a side view thereof. In this case, there is a golf bag type curtain 69 with a decorative front 71, and with a recess 73 at top 81 containing a plurality of removable miniature golf clubs, such as clubs 77 and 79. Bottom 75 is connected by hidden biscuit fasteners to base 91, which has a flat top 93 to receive a fire extinguisher, and a flat bottom 95 for stand alone usage.

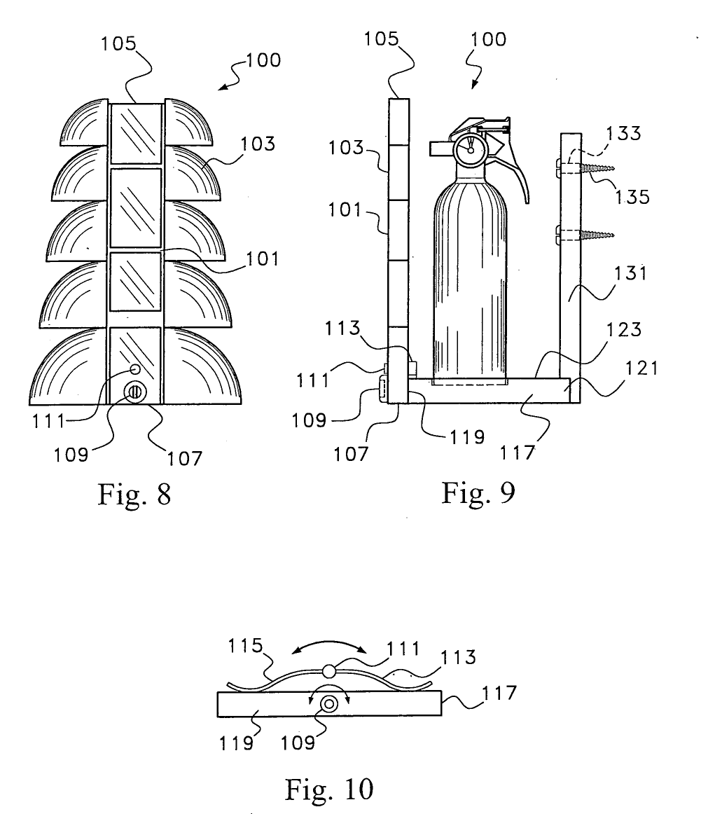

FIGS. 8, 9, and 10 illustrate front, side and cut front views a preferred embodiment of the present invention device 100 for wall mounting. It includes a plastic curtain 101, with a decorative front 103, a top 105 and a bottom 107. It is connected to base 117 via an axle and shaft 109, and is rotatable thereon. There is also a fastener 111 connected to curtain 101 and that is connected to springs 113 and 115 on its back (shown in FIG. 10 with the curtain 101 removed). This enables the curtain to be rotated a quarter circle to the left or right to permit frontal access to extinguisher 141.

At the back 121 of base 117 is a wall attachment means 131, connected by biscuits (not shown). This is an upright with orifices for screws or nails, for example, screw 135 at orifice 133. The device 100 is screwed onto a wall or other vertical surface, and will hold an extinguisher 141, as shown. The curtain may be rotated for frontal access to the extinguisher 141.

Obviously, numerous modifications and variations of the present invention are possible in light of the above teachings. For example, the device may include one or more partial of full side walls without exceeding the scope of the invention. It is therefore understood that within the scope of the appended claims, the invention may be practiced otherwise than as specifically described herein.

1. A concealing fire extinguisher storage device, which comprises:
(a.) a base having a front and a back, and having a flat bottom, and having a top adapted to receive a cylindrical fire extinguisher, and having curtain attachment means for attaching a curtain thereto, the curtain attachment means being adjacent the top and the front;
(b.) a curtain attached to the curtain attachment means, the curtain being located at the front of the base and extending upwardly therefrom, the curtain being of sufficient height to conceal a cylindrical fire extinguisher, the curtain having a façade with a decorative theme thereon.

2. The concealing fire extinguisher storage device of claim 1 wherein the curtain is a solid planar member made of a material selected from the group consisting of metal, wood, plastic and combination thereof.

3. The concealing fire extinguisher storage device of claim 1 wherein the base has a substantially circular shape from a top view.

4. The concealing fire extinguisher storage device of claim 1 wherein the base has a substantially rectilinear shape from atop view.

5. The concealing fire extinguisher storage device of claim 1 wherein the curtain is a curvilinear member having an arcuate shape from a top view.

6. The concealing fire extinguisher storage device of claim 1 wherein the curtain has a front perimeter in the shape of a predetermined theme.

7. The concealing fire extinguisher storage device of claim 1 wherein the top of the base includes a circular shaped recess area adapted to receive a fire extinguisher.

8. The concealing fire extinguisher storage device of claim 1 wherein the curtain is permanently and fixedly attached to the base.

9. The concealing fire extinguisher storage device of claim 1 wherein the curtain is removably attached to the base.

10. The concealing fire extinguisher storage device of claim 9 wherein there are a plurality of interchangeable curtain that are removably attachable to the base.

11. The concealing fire extinguisher storage device of claim 1 wherein the curtain includes a rigid frame an a flexible facade member attached is the frame.

12. The concealing fire extinguisher storage device of claim 11 wherein the flexible façade member is a fabric.

13. The concealing fire extinguisher storage device of claim 1 wherein the curtain includes at least one recessed area for insertion of at least one theme item.

14. The concealing fire extinguisher storage device of claim 13 wherein the curtain includes at least one theme item inserted in the recessed area.

15. A concealing fire extinguisher storage device, which comprises:
(a.) a base having a front and a back, and having a flat bottom, and having a top adapted to receive a cylindrical fire extinguisher, and having curtain attachment means for attaching a curtain thereto, the curtain attachment means being adjacent the top and the front;
(b.) a curtain attached to the curtain attachment means, the curtain being located at the front of the base and extending upwardly therefrom, the curtain being of sufficient height to conceal a cylindrical fire extinguisher, the curtain having a façade with a decorative theme thereon;
(c.) wall attachment means connected to the back of the base.

16. The concealing fire extinguisher storage device of claim 15 wherein the curtain is a solid planar member made of a material selected from the group consisting of metal, wood, plastic and combination thereof.

17. The concealing fire extinguisher storage device of claim 15 wherein the base has a substantially rectilinear shape from a top view.

18. The concealing fire extinguisher storage device of claim 15 wherein the curtain has a front perimeter in the shape of a predetermined theme.

19. The concealing fire extinguisher storage device of claim 15 wherein the wall attachment means is a vertically extending member attached to the base, and includes at least one of a wall attachment fastener and a wall attachment fastener orifice.

20. The concealing fire extinguisher storage device of claim 15 wherein the curtain is moveable to create frontal access to a fire extinguisher.
